(19) United States
(12) Patent Application Publication
(10) Pub. No.: US 2007/0256983 A1
(43) Pub. Date: Nov. 8, 2007

(54) STORMWATER TREATMENT SYSTEM WITH AUTOMATED CONTAMINANT BUILDUP DETECTION

(76) Inventors: Jeffrey B. Hinckley, New Gloucester, ME (US); David R. Charlton, Saco, ME (US); Daniel P. Cobb, Portland, ME (US); Shawn W. Gamash, Saco, ME (US); Vaikko P. Allen II, Santa Monica, CA (US)

Correspondence Address: THOMPSON HINE L.L.P.;Intellectual Property Group, P.O. BOX 8801, DAYTON, OH, 45401-8801, US

(21) Appl. No.: 11/736,858

(22) Filed: Apr. 18, 2007

Related U.S. Application Data
(60) Provisional application No. 60/793,772, filed on Apr. 21, 2006.

(51) Int. Cl. C02F 1/00

(52) U.S. Cl. 210/739; 210/85; 210/143

(57) ABSTRACT

A stormwater treatment system for separating contaminants from flowing stormwater is provided. The stormwater treatment system includes a tank including an inlet for receiving stormwater runoff and an outlet for outputting stormwater subsequent to treatment. The tank includes a storage chamber for collecting pollutant. A sensor is provided within the tank and arranged and configured to generate a pollutant level indicative signal. A control system is in communication with the sensor. The control system is operable, based upon the pollutant level indicative signal, to identify when pollutant build-up within the storage chamber reaches a level requiring service and to responsively output a service notification.

### CROSS-REFERENCE TO RELATED APPLICATIONS

This application claims priority to U.S. Provisional Application No. 60/793,772, entitled “Remote Monitoring System and Related Liquid Treatment Systems and Methods,” filed Apr. 21, 2006, the details of which are hereby incorporated by reference in their entirety.

### TECHNICAL FIELD

The present invention relates to stormwater treatment systems. More particularly, the present invention relates to systems for monitoring liquid treatment systems to detect events indicating a need for maintenance or service.

### BACKGROUND

Stormwater treatment systems have been and will remain an important aspect of municipal services and commercial facilities management. The protection of ground water and natural bodies of water requires systems for diverting and/or treating water that contacts roadways, parking lots, and other man made structures. If such diversion or treatment systems are not provided, particulate and contaminants located on or forming part of such structures may be carried by drain water or stormwater to the natural water bodies and contaminate them. Local, state and federal laws and rules require municipalities, businesses and, in some instances, private entities, to establish means to reduce particulate and contaminant levels permissibly transferred to natural bodies of water from property under their control. Particular requirements may vary from jurisdiction to jurisdiction, but all are likely to become more, rather than less, stringent.

Previously, municipal water transfer and treatment facilities provided the only mechanism for diverting contaminated water away from natural bodies of water, either for holding or treatment for subsequent transfer to natural settings. In general, that process involved, and continues to involve, the establishment of a system of drains, such as in a parking lot or at a street curb, by which water enters a system of pipe conduits. Eventually, the water received from the drains reaches either a final outlet destination or is directed to a treatment system for contaminant removal. For purposes of the description of the present invention, “contaminated water” is to be understood to mean any water including pollutants such as: floating particulate, such as Styrofoam™ products and oil, for example; non-floating particulate, such as sand and silt, for example; and/or entrained contaminants, such as dissolved nutrients or metals, for example. All of these undesired materials will be, in most instances, referred to herein generally as pollutants.

Land development produces increased levels of drain water and stormwater runoff, resulting in increased strain on existing water transfer and treatment infrastructure and an increased likelihood of natural water contamination. In an effort to reduce the impact of development on natural resources and municipal services, initial upstream liquid treatment has become a requirement in many land development, restoration and repair projects. That is, requirements in various forms have been established to ensure that before contaminated water enters the municipal water transfer and/or treatment system, that it is treated in a manner that reduces the level of contaminants entering the municipal system. Therefore, most new land development plans and upgrades to existing paved surfaces involve the insertion of a preliminary separation system, generally for connection to the municipal water-handling infrastructure. These separation systems may be located in heavily traveled and remote areas. They may be relatively easy to access or relatively difficult.

Preliminary separation systems may be designed with the capability to receive liquid flowing in at a wide range of rates. For example, a mild rainfall resulting in rain accumulation of less than 0.25 inches over a span of 24 hours produces a relatively low flow rate through the system. On the other hand, for example, a torrential rainfall resulting in rain accumulation of more than two inches over a span of three hours produces relatively high flow rates through the system. It may be desirable, then, to have a separation system capable of handling variable liquid flow rates with reduced likelihood of backup and flooding of the surface above. It may also be desirable to control the flow through the system such that trapped particulates are not scoured or washed out of the device and re-entrained during high flows for passage downstream.

In addition to having a reasonable liquid flow throughput capacity, the separation system may be capable of performing the separation function for which it is intended. For example, it may be required to remove from the liquid flow path a certain number, type, or size of non-floating particulate. There is an increasing need and requirement for separation systems associated with drain water and stormwater introduction to municipal water handling systems. However, it is important that they be relatively easy to inspect and maintain.

The non-floating particulates, such as grit, bottles, and anything with a specific gravity greater than water, accumulates in the tank or storage chamber used to hold separated particulates until such time as they are removed. An excess accumulation of particulates can reduce system operating efficiency. Unfortunately, the maintenance intervals for particulate removal are dependent upon a variety of things, including water flow conditions, the size of the tank, the location of the tank, and so on. As a result, it may be difficult to establish a regular maintenance cycle for this type of system. Moreover, a current inspection practice is to open a manhole or other cover, look into the tank or insert a measuring stick, and try to determine if there is enough non-floating particulate accumulation in the tank to justify removal. This method can lead to unnecessary inspection activities when the accumulation does not justify a cleaning and separation problems when the accumulation exceeds a desired level. The time spent performing inspections can be considerable and costly depending on the location of the particular tank or tanks to be inspected and cleaned. Further, regular onsite inspections may aid in system optimization, but are generally not implemented in practice, particularly without regulatory requirements for such action. Many regulatory agencies lack the personnel and funding required to complete the required number of inspections to ensure optimum system performance.

While many separation systems provide satisfactory particulate removal capability, they are limited in those cases where very fine and entrained contaminants are contained in the liquid. For that reason, detention systems, biofiltration swales, settling ponds, liquid/particle density separators, mechanical separators and media absorbers and filters are employed as alternative and/or additional types of liquid treatment systems for which the present invention may be suitable. Above-ground detention systems, swales and settling ponds take up significant real estate and are therefore generally not particularly desirable in many settings. Thus, below-ground liquid treatment systems are desirable. They take up less above-ground space, but may require more frequent, and time consuming inspections. Existing absorbers and filter mechanisms may be effective at removing specified contaminants; however, they tend to do so at the expense of flow through rates. That is, the treatment rate of filtration systems is relatively low. Regulations regarding the removal of suspended/fine solid particulates and/or dissolved and un-dissolved chemical contaminants have resulted in the need for supplemental removal arrangements to aid in the operation of the separation systems suitable for the removal of bulk floating and non-floating particulates. An arrangement for monitoring such liquid treatment filtration systems, as well as other types of liquid treatment systems, from a remote location is therefore desirable to ensure optimal system operation and regulation compliance.

As can be seen, there are a variety of types of liquid treatment systems, including those with screens to trap floating and neutrally buoyant particulates prior to exiting the system, and those with supplemental filter devices. What is needed is a system and related method for efficient inspection and maintenance of liquid treatment systems including, but not limited to, drain water and stormwater separation systems. What is also needed is such a system and related method that enables reliable monitoring of system conditions within the treatment system in order to produce indications of when maintenance is required. The system and related method may be suitable for detecting among any one or more of an array of indications of maintenance needs including, but not limited to, pollutant levels, pressure drop across filter cartridges, and trash accumulation in screening systems.

### SUMMARY

A system and related method for efficient inspection and maintenance of liquid treatment systems such as drain water and stormwater separation systems is provided. Such a system and related method may enable reliable inspection of system conditions within a treatment system in order to produce indications of when maintenance is required. Further, such a system and related method may be suitable for detecting among any one or more of an array of indications of maintenance needs including, but not limited to, pollutant levels, pressure drop across filter cartridges, and trash accumulation in screening systems.

In one aspect, a remote monitoring system automatically inspects treatment systems such as drain water and stormwater treatment systems for indications that maintenance may be required. The monitoring is performed locally at the site of the treatment system, but the indication may be forwarded to a remote location for action. That is, information regarding particulate accumulation is obtained from within the treatment system using an indication system, transferred to a communication and/or processing system, and communicated to a computing system or operator located away from the treatment system location. The monitoring system includes one or more sensors positioned within the treatment system (e.g., the tank). The one or more sensors may be capacitive, optical, ultrasonic, ion specific or pressure types but not limited thereto. Upon a change in condition, such as a blocking of the sensor active area, data (analog, digital, serial, or any other form of interest) is transferred to a signal processor. The signal processor may include a function for determining whether the sensor output establishes a particular condition indicating a “full” treatment system or clogged filters or screens. If that determination is made, the communication system sends a communication indicating the need for maintenance, whether by wired communication systems where available, or by wireless or satellite communication, to a control or notification system, such as a pager, computer system, maintenance facility telephone, or the like. The signal processing may also occur at the control/monitor location rather than at the treatment site.

In one embodiment, the indication system includes commercially available hardware including: a capacitance point level, infra red emitter/sensor, sonar or ultrasonic sensor, a wireless or satellite remote monitoring/communication system, and a battery, which may be a DC battery, a solar-charged battery assembly, or other power supply of choice. The sensor is installed in the treatment system, such as in a collection tank, and positioned at an appropriate location to detect when the tank is full and/or requires maintenance. The communication system hardware may be installed on a nearby structure such as a pole or building in such manner as to provide adequate solar gain and wireless communications signal. In some embodiments, indication system hardware, such as a power box, may be placed within the treatment system (e.g., hole, vault, etc.). A cable may be routed between the sensor, power box, communication system and/or processing system to provide power and signal transmission.

During a liquid movement event, liquid flows into the liquid treatment system. An example of such a treatment system is the separation system described in U.S. Pat. No. 5,759,415 issued to Adams on Jun. 2, 1998, assigned to Vortechnics, Inc. and entitled METHOD AND APPARATUS FOR SEPARATING FLOATING AND NON-FLOATING PARTICULATE FROM RAINWATER DRAINAGE, where contaminants are separated out and collected in a treatment or storage chamber. Once accumulated pollutant, a blocked filter, a pressure drop or the like is detected by the sensor, its output will indicate that a change has occurred and the output can be used to determine whether maintenance is required or may be required soon. In one embodiment, the monitoring system periodically checks the treatment system for a change, such as a change in accumulated pollutant, pressure drop and/or the like and this information is transmitted to an information gathering source, website, text message, email, etc. where the information is stored. This stored data can provide a historical record as well as verifiable data. In some embodiments, the monitoring system may consist of probes, switches, etc. that provide a yes/no answer to an inquiry. As one example, the monitoring system may include one or more probes that provide yes/no data to inquiries as to whether or not pollutant, pressure drop, etc. requires maintenance or some proportion of capacity is reduced and maintenance may be required in the future. Once a criterion is satisfied, the monitoring system communicates an alarm, e.g., via a wireless communications network, satellite or land line to an automated web site server. Upon receipt of the alarm, the web site notifies previously designated personnel to initiate system inspection and possible maintenance action. The notification can be in the form of, but not limited to, an e-mail, fax, pager, cell phone call or text message. The system may contact a website, email, text message, owner, regulator, municipality, etc.

Without a remote monitoring system, a full tank or blocked filter condition may go unnoticed, and subsequent liquid movement events may cause pollutants to bypass or wash out of the treatment system. The system and related method of the present invention may be used to overcome that problem in a manner that ensures service maintenance will only be requested and performed when needed. The system and related method of the present invention may be used in any liquid treatment system, such as separation or detention systems, for which inspection is of interest. It is not intended to be limited to the example separation system described herein. Instead, for the purpose of clarification, the present invention may be used with any liquid treatment system, including but not limited to separation and detention systems. These and other features of the invention are set forth in the accompanying drawings and the description below. Other features, objects, and advantages of the invention will be apparent from a review of the description and drawings.

### BRIEF DESCRIPTION OF THE DRAWINGS

FIG. 1 is a simplified block representation of the remote monitoring system of the present invention;

FIG. 2 is a diagrammatic view of an embodiment of a stormwater treatment system including remote monitoring system;

FIG. 3 is another embodiment of a stormwater treatment system including remote monitoring system;

FIG. 4 is a side view of an embodiment of a sensor for detecting pollutant level within a stormwater treatment system;

FIG. 5 is a perspective view of an embodiment of a stormwater treatment system including remote monitoring system;

FIG. 6 is a front view of an embodiment of a control unit; and

FIG. 7 is a diagrammatic, side view of another embodiment of a stormwater treatment system including remote monitoring system.

### DETAILED DESCRIPTION

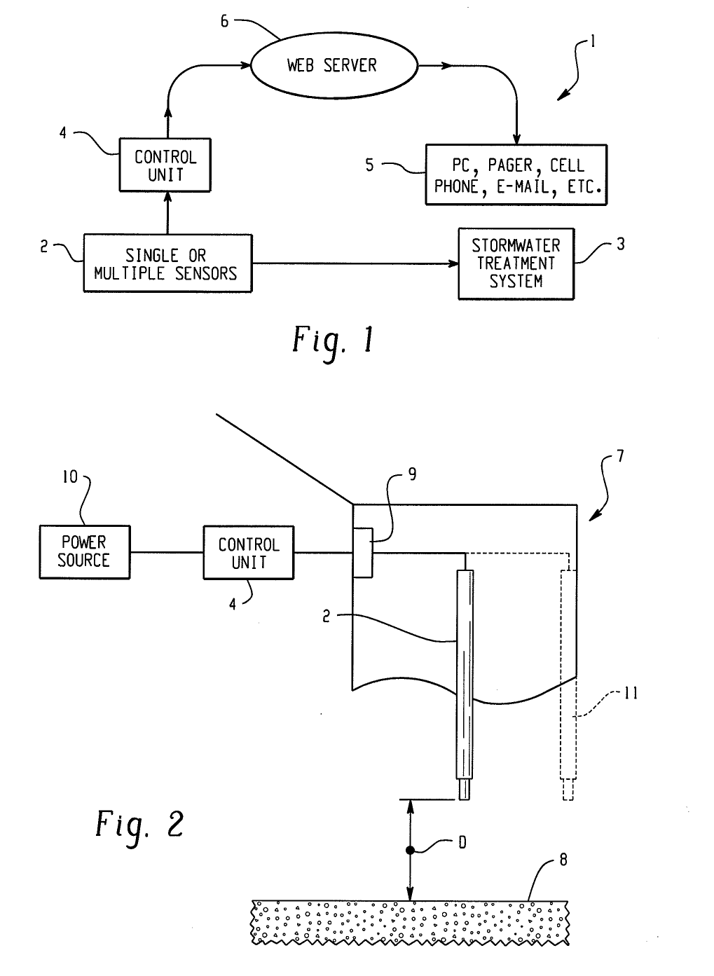

FIG. 1 shows a relational arrangement 1 among primary components of a remote monitoring system. The system includes one or more sensors 2 that are removably installable in, on or near a stormwater treatment system 3 to be monitored. The stormwater treatment system 3 may be monitored for any one or more of a variety of types of information. The one or more sensors 2 are selected and arranged according to the desired monitoring information of the liquid treatment system 3. The one or more sensors 2 are coupled to a signal processing device, which may be part of control unit 4. The control unit 4 may further include communications electronics as well. The processing device may be in communication, either wired or wirelessly, with a remotely located contact 5. The contact may either be a direct contact or an indirect contact, such as through an Internet connection and/or through a control server, including, but not limited to, a web server 6.

Referring to FIG. 2, in one embodiment, sensor 2 is a pollutant level sensor that detects a change in the pollutant level within a treatment system 7. As a pollutant level sensor 2, the sensor may be a sonar sensor arranged to transmit an acoustic pulse and detect echoes indicating changes in a distance D between the sensor and the surface 8 thereunder, which may be at least partially formed by accumulated pollutant. The sensor 2 is connected to a power unit 9 (e.g., including a rechargeable battery), which is connected to the control unit 4 including the signal processing device. The control unit 4 is connected to a power supply 10, which may be, but is not limited to, a solar panel array. In some embodiments, the sensor 2, power unit 9, control unit 4 and power supply 10 may be connected using a wired connection that may at least partially be run underground.

The signal processing device of the control unit 4 includes one or more functions for receiving signals from the sensor 2, analyzing those signals and making a decision whether a specified pollutant level has been reached within the treatment system (e.g., by comparing the processed value to a value saved in memory). In some embodiments, the signal processing device determines whether a specified change in pollutant level has occurred. If the specified pollutant level has been reached, a communication is generated advising an entity or one or more individuals that the pre-established treatment system pollutant level has been reached. In some implementations, an initial indication is generated that a specified percent change has occurred and service may be due at a future date, which may be verified by a second sensor 11 (shown by dotted lines) which will indicate that service is actually required. Verification may also be completed by using historical data. As noted, the communication may be made directly in a wired manner, or through a communication network, such as the Internet.

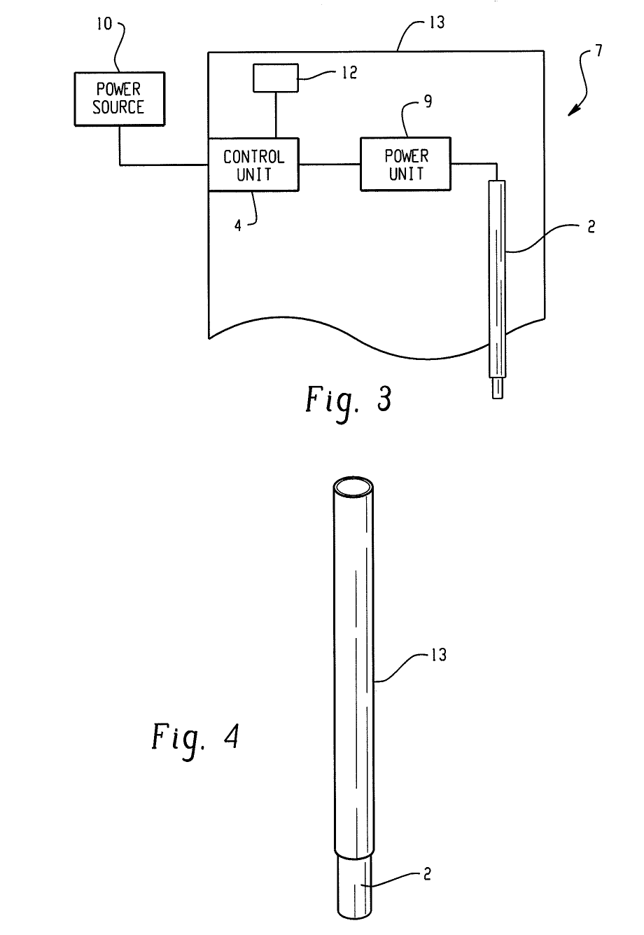

Referring now to FIG. 3, the sensor 2, power unit 9 and control unit 4 are positioned within the treatment system 7, and a communication antenna 12 is mounted at or near the top 13 of the treatment system such that most (e.g., see power source 10), if not all, of the entire remote monitoring system may be contained within the structure of the treatment system. It is to be understood that alternative forms of the sensor 2 may be employed, that the sensor may be used to detect other conditions, such as filter blockage (e.g., using a particulate detector) or pressure drops (e.g., using a pressure sensor), and that one or more sensors may be employed to detect one or more types of conditions within the tank for maintenance purposes. Further, the remote monitoring system may be used to detect other indications or conditions of interest. For example, Biological Oxygen Demand (e.g., using an oxygen detector), pH level (e.g., using a pH detector), temperature (e.g., using a temperature sensor), and/or other conditions of interest may be sensed and the information transmitted to the user at a remote location. These conditions may or may not signal a need for maintenance specifically. Instead, they may be data of interest to the user for information regarding the liquid treatment function and/or the liquid passing through the treatment system.

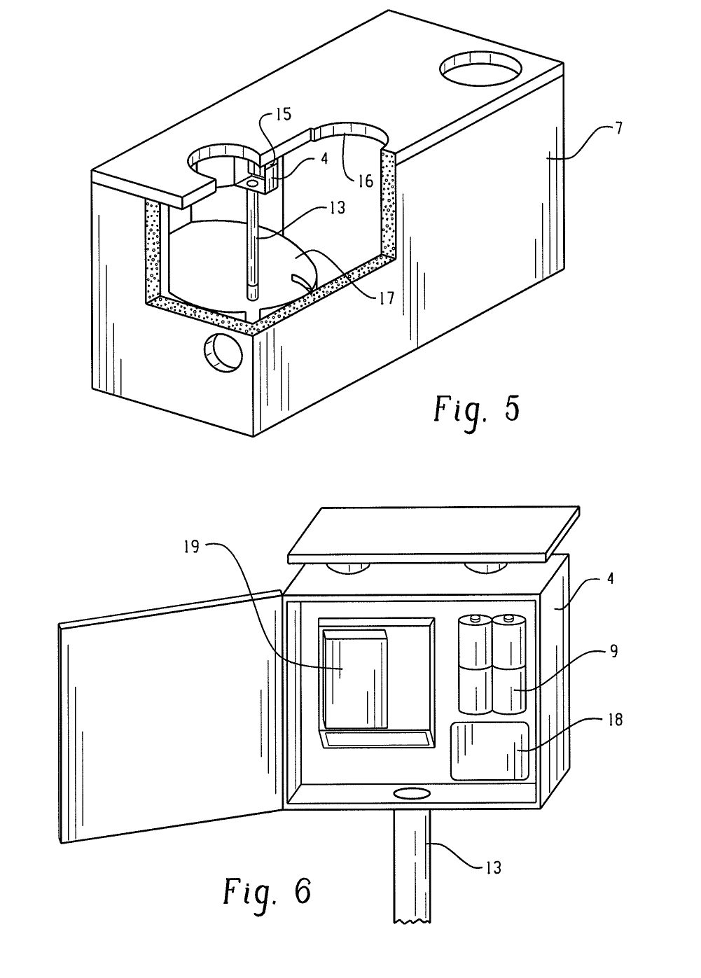

In an exemplary embodiment shown in FIGS. 4-6, a portion of the components are contained in a treatment system 7 and the remainder external thereto. As illustrated in FIG. 4, the sonar sensor 2 is shown mounted to a substrate 13, such as a PVC pipe. As shown in FIG. 5, the PVC pipe is attached to the control unit 4 with a mounting plate 15 which affixes to an interior surface 16 of the treatment system 7 above a bottom of a tank 17 of the treatment system where non-floating particulates are to accumulate. The control unit 4 is shown in greater detail in FIG. 6. The sensor 2 is electrically connected to a signal processing device 18 contained within the control unit 4. The control unit 4, in this embodiment, includes therein the power unit 9, such as a 12 volt battery. The control unit 4 also includes communication hardware 19, such as a serial/IP data device and/or a cellular modem. The communication hardware 19 is optionally configured to send all data and system alerts to a remote location, which may be embodied in an e-mail address, ftp server, a telephone number, or a pager number, but not limited thereto.

The monitoring system may further include a function to regulate and optimize power consumption. Specifically, the monitoring system may include a low power consumption timer relay. This function allows the system to ‘wake-up’ for data transmission and return to ‘sleep’ until the next scheduled transmission. This function extends battery life, which may extend the maintenance cycle and costs associated with the monitoring system.

In operation, the sensor 2 transmits data on a predetermined schedule with the timer relay, which schedule may be any time frame selectable and changeable by the user. The transmission schedule defined is based on one or more selectable maintenance triggers and the particular operations of the treatment system within which the remote monitoring system is deployed. This schedule may be adjusted through direct communication with the system. Once a change indicates maintenance is required, or that a certain percent reduction in capacity has occurred, the monitoring system sends a notification in the form of an e-mail, fax, pager, cellular phone call, or text message.

In one embodiment for pollutant level detection, the sensor 2 is a sonar sensor, such as an Actisense SMART™ sonar transducer available from Active Research Limited of Dorset, United Kingdom. The sensor 2 is connected to a COM1000 industrial internet appliance available from Simple Com Tools of Indian Trail, N.C. The COM1000 facilitates the data transfer through the Wireless M2M express modem available from Blue Tree Wireless Data Inc. of Reston, Va. Both the COM1000 and M2M modem are preferably controlled by a processor, such as the PRC1000 timer relay, which is also a product of Simple Com Tools. NEMA enclosures, power supply systems, and general wiring are available from a variety of commercial suppliers.

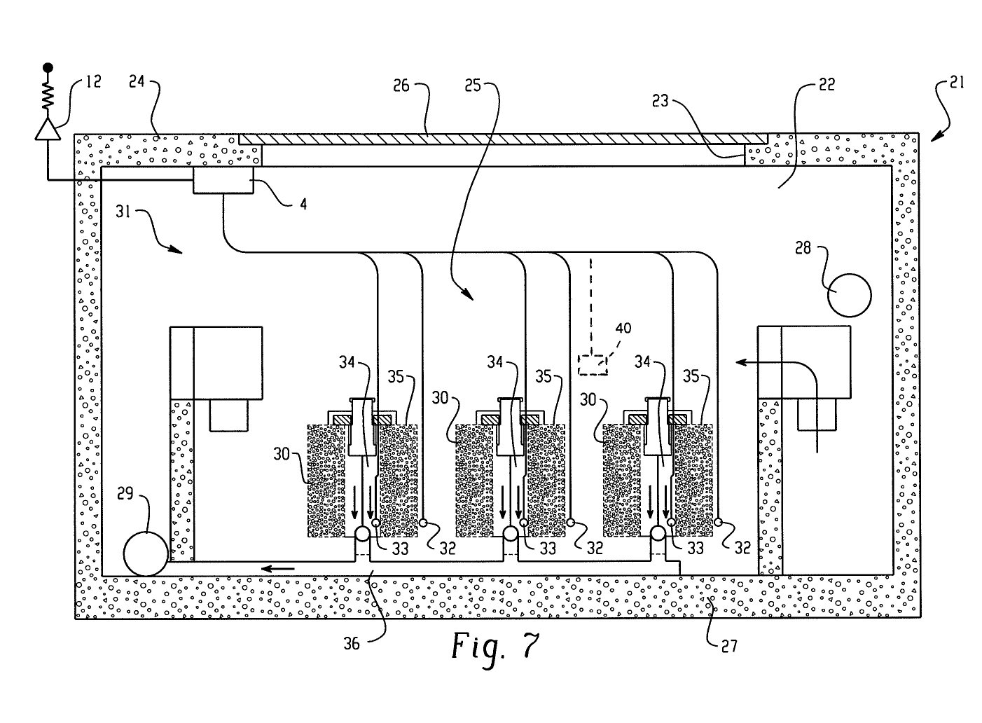

Referring to FIG. 7, a stormwater treatment system 21 includes a vault 22 having an access opening 23 at a top 24 of the vault through which access can be gained to an interior 25 of the vault (e.g., by removing cover 26) and a floor 27 that, in the illustrated embodiment, is formed of concrete. The stormwater treatment system 21 further includes an inlet 28 through which stormwater enters the vault 22 and an outlet 29 through which stormwater exits the vault. A manifold of filter assemblies 30 are located in the interior 25 of the vault 22 for use in filtering stormwater entering through the inlet. The filter assemblies 30 are connected to and in communication with a filter conduit 36 that directs filtered stormwater from filter media 35 toward the outlet 29. A suitable filter assembly is described in pending U.S. Pat. Ser. No. 10/647,102, filed Aug. 21, 2003, the details of which are hereby incorporated by reference as if fully set forth herein.

The stormwater treatment system 21 includes a monitoring system 31 for use in monitoring pollutant build-up within the filter assemblies 30. The monitoring system 31 includes an outside pressure sensor 32 positioned outside the filter assembly 30 and an inside pressure sensor 33 positioned within a drainage space 34 within the filter assembly. The pressure sensors 32 and 33 are each connected to a control unit 4 including power unit, which is connected to communication antenna 12.

In operation, if pollutant builds up within one or more of the filter assemblies 30, then stormwater flow through the filter media 35 will be restricted and eventually blocked. The pressure sensors 32 and 33 can be used to measure pollutant build-up by calculating a pressure differential from inside the filter assembly 30 to outside the filter assembly. As the filter media 35 begins to retain pollutant, the pressure difference from inside the filter assembly to outside the filter assembly will get larger until ultimately the filter media is clogged and the outside pressure sensor 32 will measure the static head of standing water in the vault and the inner pressure sensor 33 will have no water to measure as the clogged filter media will not allow water to pass therethrough to the drainage space 34. The signals from the sensors 32 and 33 may be processed using the control unit 4 to identify when pollutant build-up within the filter assembly 30 reaches a predetermined level at which point a service indication may be transmitted via communication antenna 12.

It is to be understood that the above description is intended to provide an indication of the primary aspects of the invention and that additional components to complete functionality will be readily recognized by those skilled in the art. It is to be understood that other application and equivalents are possible. For example, an infrared sensor may be used to indicate the presence of pollutant build-up. Referring to FIG. 7, for example, an infrared sensor 40 is located within the vault 22. The sensor 40 may be configured to detect presence of an infrared beam. When a pollutant level rises to a pre-selected height thereby blocking the infrared beam, the infrared sensor provides an indication to the control unit 4. Accordingly, other embodiments are within the scope of the following claims.

What is claimed is:

1. A stormwater treatment system for separating pollutants from flowing stormwater, comprising:
a tank including an inlet for receiving stormwater runoff and an outlet for outputting stormwater subsequent to treatment, the tank including a storage chamber for collecting pollutant;
a sensor within the tank and arranged and configured to generate a pollutant level indicative signal; and
a control system in communication with the sensor, the control system operable, based upon the pollutant level indicative signal, to identify when pollutant build-up within the storage chamber reaches a level requiring service and to responsively output a service notification.

2. The stormwater treatment system of claim 1 wherein the control system includes a wireless communication device that wirelessly transmits the service notification.

3. The stormwater treatment system of claim 1, wherein the sensor is a sonar sensor that is configured to detect a distance between the sonar sensor and pollutant collected in the bottom of the storage chamber.

4. The stormwater treatment system of claim 2, wherein the control system processes the pollutant level indicative signal by determining a change in the pollutant level.

5. The stormwater treatment system of claim 3, wherein the control system compares the change in the pollutant level to a predetermined threshold value.

6. The stormwater treatment system of claim 1 further comprising a rechargeable battery that provides power to the sensor and a power source that is used to recharge the battery.

7. The stormwater treatment system of claim 5, wherein the power source comprises a solar panel.

8. The stormwater treatment system of claim 1 further comprising mounting structure that mounts the sensor to an interior surface of the storage chamber.

9. The stormwater treatment system of claim 1 wherein the control system comprises a number of distributed processing devices.

10. The stormwater treatment system of claim 9 wherein a first processing device of the control system is located in proximity to the tank and a second processing device of the control system is located remotely from the tank, a wireless communication link is provided between the first processing device and the second processing device.

11. The stormwater treatment system of claim 9, wherein a first processing device located in proximity to the tank can be programmed remotely using a cellular connection, a satellite connection and/or a land line connection.

12. The stormwater treatment system of claim 1, wherein the sensor is a first sensor, the stormwater treatment system further comprising a second sensor located in the tank and arranged and configured to generate a pollutant level indicative signal.

13. A method of operating a stormwater treatment device, the method comprising:
locating a sensor within the stormwater treatment device, the sensor generates at least one signal indicative of contaminant buildup in the stormwater treatment device;
processing the signal generated by the sensor using a processor to identify when contaminant buildup in the stormwater treatment device reaches a threshold level; and
automatically issuing a service notification using a communication device based on the output generated by the processor.

14. The method of claim 13 wherein the sensor generates an acoustic pulse and detects an echo from the acoustic pulse, a time difference between generation of the acoustic pulse and detection of the echo indicating a distance between the sensor and pollutant buildup in the bottom of a storage chamber of the stormwater treatment device.

15. The method of claim 13, wherein the sensor comprises a pressure sensor that is used to detect contaminant buildup on one or more filter devices within the stormwater treatment device.

16. The method of claim 13, wherein the service notification is communicated wirelessly using a communication device.

17. The method of claim 13 further comprising locating a processor and communication device outside the stormwater treatment device.

18. The method of claim 13 further comprising performing a service operation on the stormwater treatment device in response to the service notification.

19. The method of claim 13 further comprising controlling operation of the sensor using a programmable relay controller connected to the sensor.

20. The method of claim 19 further comprising programming the programmable relay controller to activate the sensor based on a pre-selected schedule.

21. A stormwater treatment system for separating contaminants from stormwater, comprising:
a chamber for receiving stormwater runoff;
at least one sensor within the chamber and arranged and configured to generate a signal indicative of contaminant buildup within the stormwater treatment system;
a control system in communication with the sensor, the control system operable, based upon the signal, to identify when contaminant buildup reaches a level requiring service and to responsively output a service notification.

22. The stormwater treatment system of claim 21 wherein the chamber is a storage chamber, the sensor is a sonar sensor, the signal generated by the sonar sensor is indicative of contaminant buildup in the bottom of the storage chamber.

23. The stormwater treatment system of claim 21 wherein the chamber contains at least one filter device, the signal generated by the sensor is indicative of contaminant buildup on the filter device.

24. The stormwater treatment system of claim 21 further comprising a programmable relay controller operatively connected to the sensor and programmed to control delivery of power to the sensor.
